(19) United States
(12) Patent Application Publication
(10) Pub. No.: US 2003/0200084 A1
(43) Pub. Date: Oct. 23, 2003

(54) Noise reduction method and system

(76) Inventors: Youn-Hwan Kim, Seongnam-city (KR); Chun-Mo Kang, Namyangju-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/417,022

(22) Filed: Apr. 16, 2003

(30) Foreign Application Priority Data
Apr. 17, 2002 (KR) 10-2002-0020846

(51) Int. Cl. G10L 21/02

(52) U.S. Cl. 704/226

(57) ABSTRACT

Disclosed is a noise reduction system comprising: a speech separator for receiving environmental noise to generate virtual noise, and subtracting the virtual noise from an externally input sound source to generate virtual speech; a digital filter for using a weight coefficient to filter the virtual noise and generate filtered speech; a subtracter for subtracting the filtered speech generated by the digital filter from the virtual speech to calculate an error; and a weight coefficient generator for using the error and the virtual speech to update the weight coefficient so as to reduce the error. Here, the weight coefficient generator updates weight coefficients in real-time using the steepest descent method so as to minimize a mean square value of the error.

### CROSS REFERENCE TO RELATED APPLICATION

This application is based on Korea Patent Application No. 2002-20846 filed on Apr. 17, 2002 in the Korean Intellectual Property Office, the content of which is incorporated herein by reference.

### BACKGROUND OF THE INVENTION

(a) Field of the Invention

The present invention relates to a noise reduction method and system. More specifically, the present invention relates to a noise reduction method using an adaptive algorithm.

(b) Description of the Related Art

Many methods have been proposed to reduce noise functioning as pollution in the speech recognition field. Noise causes serious problems in various fields, and in particular, it becomes extremely critical to reduce the noise by certain degrees in cases wherein accurate speech inputs are required. Conventional noise reduction methods provide manual noise reduction such as by reducing the noise using a soundproof wall. However, the above-noted manual noise reduction method is not suitable for reducing many other sorts of noise.

For example, if mixed speech and noise are input to a speech recognition device, the device cannot recognize the accurate speech and it fails to obtain desired results. Accordingly, the speech recognition device has a problem in reducing the noise using the conventional manual noise reduction method.

### SUMMARY OF THE INVENTION

It is an advantage of the present invention to actively reduce noise using adaptive coefficients.

In one aspect of the present invention, a noise reduction system comprises: a speech separator for receiving environmental noise to generate virtual noise, and subtracting the virtual noise from an externally input sound source to generate virtual speech; a digital filter for using a weight coefficient to filter the virtual noise and generate filtered speech; a subtracter for subtracting the filtered speech generated by the digital filter from the virtual speech to calculate an error; and a weight coefficient generator for using the error and the virtual speech to update the weight coefficient so as to reduce the error.

The weight coefficient generator uses the steepest descent method so as to update the weight coefficient so that a mean square value of the error may be a minimum.

In another aspect of the present invention, a noise reduction method comprises: (a) externally receiving noise to generate virtual noise; (b) filtering the virtual noise by using a weight coefficient to generate filtered speech; (c) calculating a difference between virtual speech generated by removing the virtual noise from externally input speech and the filtered speech to generate an error; and (d) updating the weight coefficient using the error and the virtual noise.

(b) comprises generating the filtered speech using

$${\sum }_{l = 0}^{L - 1} {w}_{i} ( n ) \times ( n - l ) ,$$

where wₗ(n) is the weight coefficient, and x(n−l) is the virtual noise.

(d) comprises updating the weight coefficient using wₗ(n)+μx(n−l)e(n), where wₗ(n) is the weight coefficient, μ is a constant for indicating a step size, x(n−l) is the virtual noise, and e(n) is the error.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a noise reduction system according to a preferred embodiment of the present invention;

FIG. 2 shows a flowchart of a noise reduction method according to a preferred embodiment of the present invention; and

FIG. 3 shows a flowchart of a method for updating adaptive coefficients according to a preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

With reference to drawings, a noise reduction method and system according to a preferred embodiment of the present invention will be described.

FIG. 1 shows a block diagram of a noise reduction system according to a preferred embodiment of the present invention.

As shown, the noise reduction system comprises a speech separator 10, a digital filter 20, a subtracter 30, and a weight coefficient generator 40.

The speech separator 10 includes an AD (analog to digital) converter to convert an externally input analog sound source into digital signals, and it separates virtual noise [x(k)] from the externally input sound source, and stores it in a buffer.

In detail, when the speech separator 10 does not receive additional speech signals to generate the virtual noise [x(k)], the surrounding noise is input to the speech separator 10 through an external input terminal, and the speech separator 10 performs Fourier transform on the input noise, separates it according to the smallest unit bands, and stores results in the buffer.

The speech separator 10 reduces the virtual noise [x(k)] stored in the buffer from the sound source to generate virtual speech [d(k)] when receiving a sound source including desired speech and noise.

The digital filter 20 receives the virtual noise [x(k)] stored in the buffer of the speech separator 10, filters the virtual noise [x(k)] according to a weight coefficient [w(k)] generated by the weight coefficient generator 40, and generates filtered speech [y(k)] from which noise is reduced.

The subtracter 30 receives the virtual speech [d(k)] from which the virtual noise [x(k)] is reduced from the speech separator 10, subtracts the filtered speech [y(k)] generated by the digital filter 20 from the virtual speech [d(k)], and finds an error [e(k)].

The weight coefficient generator 40 receives the virtual noise [x(k)] and the error [e(k)], generates a weight coefficient [w(k)], and provides the weight coefficient to the digital filter 20.

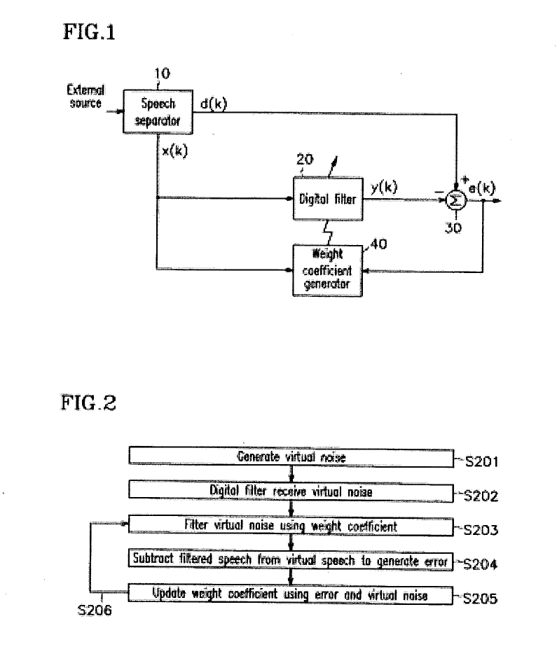

Referring to FIG. 2, a noise reduction method will be described.

FIG. 2 shows a flowchart of a noise reduction method according to a preferred embodiment of the present invention.

The speech separator 10 receives external noise without additional speech inputs, generates virtual noise [x(k)], and stores it in the buffer 12 in step S201. The noise reduction system receives no additional external speech inputs so as to generate virtual noise [x(k)]. That is, the noise reduction system is established to receive no speech, but only surrounding noise through the speech input terminal.

The noise input without external speech input is Fourier-transformed to separate frequencies and magnitudes. As described, the Fourier-transformed noise is separated for each smallest unit band, stored in the buffer 12, and inverse-Fourier-transformed to become the virtual noise [x(k)].

The virtual noise [x(k)] is input to the digital filter 20 in step S202, and filtered according to the weight coefficient [w(k)] generated by the weight coefficient generator 40 in step S203. As described, the virtual noise filtered by the weight coefficient is generated to be desired speech.

In this instance, when the virtual noise separated per band is expressed in [x(n), x(n−1), . . . , x(n−L+1)], and corresponding weight coefficients in [w₀(n), w₁(n), . . . , w_{L-1}(n)], the filtered speech [y(n)] is expressed in Equation 1:

$$y ( n ) = {\sum }_{l = 0}^{L - 1} {w}_{i} ( n ) \times ( n - l ) \qquad Equation 1$$

When the virtual noise separated per band and the weight coefficient are expressed using a vector set as expressed in Equation 2, the filtered speech [y(n)] can be shown as Equation 3.

X(n)=[x(n)x(n−1) . . . x(n−L+1)]^{T} Equation 2

W(n)=[w₀(n)w₁(n) . . . w_{L-1}(n)]^{T}

y(n)=W^{T}(n)X(n)=X^{T}(n)W(n) Equation 3

Next, the virtual speech [d(n)] obtained by subtracting the generated virtual noise from the externally input sound source is input to the subtracter 30, and a value obtained by subtracting the filtered speech [y(n)] generated by the digital filter from the virtual speech [d(n)] is defined to be an error [e(n)] which is then output in step S204. The error is expressed in Equation 4.

e(n)=d(n)−y(n)=d(n)−W^{T}(n)X(n) Equation 4

The weight coefficient generator 40 receives the error [e(n)] and the virtual noise [X(n)] to update a weight coefficient in step S205. The updated weight coefficient [W(n+1)] is used for the digital filter 20 to filter the virtual noise, and accordingly generate filtered speech [y(n+1)], and noise-reduced speech is thereby generated by repeating the above-noted process in step S206.

A method for generating a weight coefficient will now be described in detail.

As described above, the weight coefficient generator 40 requires an error and virtual noise for updating the weight coefficient. The error is a difference between virtual speech generated by subtracting virtual noise from the input speech and speech generated by filtering virtual noise by the digital filter using a weight coefficient, that is, the speech desired as a result, in the preferred embodiment of the present invention. The weight coefficient generator 40 updates a weight coefficient so as to minimize a mean square value of the error expressed in Equation 5.

ξ(n)=E[e²(n)] Equation 5

When Equation 5 is expressed using the error in the vector form, Equation 6 is obtained.

$$\begin{matrix}ξ ( n ) = E [ {( d ( n ) - {X}^{T} ( n ) W ( n ) )}^{2} ] \\ = E [ {d}^{2} ( n ) ] - 2 E [ d ( n ) {X}^{T} ( n ) ] W ( n ) + {W}^{T} ( n ) E [ X ( n ) {X}^{T} ( n ) ] W ( n ) \\ = E [ {d}^{2} ( n ) ] - 2 {P}^{T} W ( n ) + {W}^{T} ( n ) RW ( n )\end{matrix} \qquad Equation 2$$

In this instance, when using the steepest descent method as an optimization algorithm and calculating a weight coefficient [W(n)] so as to find a value for minimizing ξ(n), it is shows as Equation 7.

W(n+1)=W(n)+μX(n)e(n) where μ represents a step size. Equation 7

When Equation 7 is expressed without using the vector form, it is expressed as Equation 8.

wₗ(n+1)=wₗ(n)+μx(n−l)e(n) where l=0, 1, 2, . . . , L−1. Equation 8

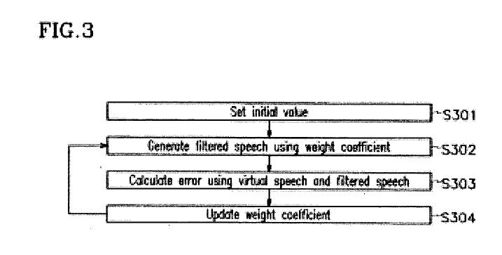

In the below, a method for updating a weight coefficient using Equation 8 will be described with reference to FIG. 3.

FIG. 3 shows a flowchart of a method for updating adaptive coefficients according to a preferred embodiment of the present invention.

First, an initial value required for finding a weight coefficient is determined in step S301. The initial value includes a step size μ and an initial value [w₁(0)] of the weight coefficient. The initial value of the weight coefficient is substituted into Equation 1 to calculate the filtered speech [y(0)] in step S302. An error between the virtual speech [d(0)] and the filtered speech [y(0)] is calculated to calculate an error [e(0)] in step S303.

Next, a weight coefficient [w₁(1)] is updated using the error [e(0)], the initial value of the weight coefficient determined in the previous step S301, and the step size in step S304. The previous steps S302 through S304 are repeated using the updated weight coefficient [w₁(1)] to find a weight coefficient.

That is, the filtered speech [y(n)] is calculated by substituting the weight coefficient [w₁(n)] into Equation 1 in step S302, the error [e(n)] that is an error between the filtered speech [y(n)] and the virtual speech [d(n)] is calculated in step S303, and a weight coefficient is updated using the error [e(n)] and the step size to obtain a new weight coefficient [w₁(n+1)] in step S304.

By updating the weight coefficient as described above, errors are reduced each time speech is input to thereby reduce noise.

According to the present invention, since the weight coefficient is updated in real-time, the noise may be reduced in real-time response to environmental changes.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A noise reduction system comprising:
a speech separator for receiving environmental noise to generate virtual noise, and subtracting the virtual noise from an externally input sound source to generate virtual speech;
a digital filter for using a weight coefficient to filter the virtual noise and generate filtered speech;
a subtracter for subtracting the filtered speech generated by the digital filter from the virtual speech to calculate an error; and
a weight coefficient generator for using the error and the virtual speech to update the weight coefficient so as to reduce the error.

2. The system of claim 1, wherein the weight coefficient generator updates the weight coefficient so that a mean square value of the error may be a minimum.

3. The system of claim 2, wherein the weight coefficient generator uses the steepest descent method so as to update the weight coefficient so that a mean square value of the error may be a minimum.

4. The system of claim 1, wherein the weight coefficient generator updates the weight coefficient using wₗ(n)+μx(n−l)e(n), where wₗ(n) is the weight coefficient, μ is a constant for indicating a step size, x(n−l) is the virtual noise, and e(n) is the error.

5. The system of claim 1, wherein the digital filter generates the filtered speech using
$${\sum }_{l = 0}^{L - 1} {w}_{i} ( n ) \times ( n - l ) ,$$
where wₗ(n) is the weight coefficient, and x(n−l) is the virtual noise.

6. The system of claim 1, wherein the speech separator further comprises a buffer for separating the virtual noise for each band and storing the same.

7. A noise reduction method comprising:
(a) externally receiving noise to generate virtual noise;
(b) filtering the virtual noise by using a weight coefficient to generate filtered speech;
(c) calculating a difference between virtual speech generated by removing the virtual noise from externally input speech and the filtered speech to generate an error; and
(d) updating the weight coefficient using the error and the virtual noise.

8. The method of claim 7, wherein (a) further comprises separating the virtual noise for each band.

9. The method of claim 7, wherein (b) comprises generating the filtered speech using
$${\sum }_{l = 0}^{L - 1} {w}_{i} ( n ) \times ( n - l ) ,$$
where wₗ(n) is the weight coefficient, and x(n−l) is the virtual noise.

10. The method of claim 7, wherein (d) comprises updating the weight coefficient so that a mean square value of the error may be a minimum.

11. The method of claim 10, wherein (d) uses the steepest descent method to update the weight coefficient.

12. The method of claim 7, wherein (d) comprises updating the weight coefficient using wₗ(n)+μx(n−l)e(n), where wₗ(n) is the weight coefficient, μ is a constant for indicating a step size, x(n−l) is the virtual noise, and e(n) is the error.
